(19) United States
(12) Patent Application Publication
(10) Pub. No.: US 2026/0297968 A1
(43) Pub. Date: Oct. 1, 2026

(54) FLOOR DEVICES AND SYSTEMS

(71) Applicant: Nuaudio Corporation, Bozeman, MT (US)

(72) Inventor: Chad Franscoviak, Bozeman, MT (US)

(73) Assignee: Nuaudio Corporation, Bozeman, MT (US)

(21) Appl. No.: 19/090,792

(22) Filed: Mar. 26, 2025

Related U.S. Application Data
(63) Continuation of application No. 19/090,740, filed on Mar. 26, 2025.

(51) Int. Cl. E04H 3/24; H04N 5/28

(52) U.S. Cl. CPC E04H 3/24; H04N 5/28

(57) ABSTRACT

A modular floor system, comprising a plurality of interconnected panels, the interconnected panels comprising at least one component attachment mechanism configured to receive additional components and at least one cable channel. An enclosure, comprising a chassis having a floor, a frame, and overhead beams, adaptable for immersive audio and/or multimedia production and experience. Multiple speaker attachment mechanisms are provided, the location of each speaker pre-determined to be at specific mounting points above, to the side, behind, and overhead of a listener, and capable of adjustment based on at least one of a pre-determined audio format and a user preference. The floor comprising a plurality of interconnected panels and perimeter panels. The frame comprising vertical uprights and overhead beams, with attachment mechanisms for speakers, lighting, acoustic treatment, projectors, and cameras.

### CROSS REFERENCE TO RELATED APPLICATIONS

This Patent Application is an application claiming priority under 35 U.S.C. §120 to U.S. patent application Ser. No. ______, entitled “ENCLOSURE DEVICES AND SYSTEMS,” filed March ______, 2025, which is incorporated by reference in its entirety for all purposes.

### TECHNICAL FIELD

The present disclosure relates generally to various devices, systems and methods for floor systems and the construction of floor systems.

### BACKGROUND

Traditional audio and multimedia production workspaces (such as a studio) are typically built in whatever space happens to be available to the proprietor of the workspace, and the acoustics of the workspace are generally addressed at the end of the building process. Consequently, there is an ongoing struggle of getting the room geometry, speaker placement, video capabilities, sound and related noise and electric isolation, workspace infrastructure (e.g., wiring and the like), and other acoustic considerations in a given room to accurately represent the music (or other audio or video) being created, presenting numerous challenges to the engineers and producers working in those spaces.

A result of such workspaces being built in unique locations, is that there is no consistency from workspace to workspace in terms of how it sounds to the engineers and producers, thus requiring significant time, energy and resources to understand and work with how each particular workspace sounds and, therefore, how they can create audio content which translates to all playback environments.

In this regard, the configuration of “fixed” studios, particularly in terms of speaker placement, room geometry, acoustics, and related equipment layout, are also fixed once the studio is constructed. For example, the walls are typically built with studs and drywall, speakers are installed into the walls, outlets are placed in the walls, and the like, and any change in speaker placement requires deconstructing walls with significant corresponding construction expense and downtime. Further still, generally speaking, even outside the realm of audio and multimedia production studios, many rooms, workshops and other similar workspaces are also built with more permanent constructions methods (i.e., studs and drywall) and thus they lack adaptability once built and, again, any changes to the room require deconstructing walls with significant corresponding construction expense and downtime.

The above nature of such studios means that they are expensive to construct and fixed in location. In other words, they cannot be transported and any expense invested in the construction of the studio remains at the location if a user moves.

Moreover, traditional music studios have developed over time to be almost exclusively used in connection with the stereo format of music—sound emanating from a fixed plane at the front of a room from two channels. While most traditional music studios work for stereo applications, the lack of flexibility in configuration makes adapting to new audio and speaker formats difficult, time-consuming and expensive. This is particularly challenging as new audio formats provide a sense of depth and space, allowing the listener to feel as if they are surrounded by the sound. As described in more detail below, these new formats, often referred to as “immersive audio,” allow a listener feel like they are in the same space as the performer or that the sound is coming from all around them. These formats are becoming increasingly prevalent and are increasingly adopted if not mandated by the music industry.

Moreover, video content is an increasingly important component of music and multimedia production, and traditional music studios rarely have a way to integrate video.

Accordingly, devices, systems and methods for adaptable enclosures and the construction of such enclosures, particularly in the field of multimedia, are desirable.

### SUMMARY

The present disclosure provides devices, systems and methods for a modular floor system, comprising a plurality of interconnected panels, the interconnected panels comprising at least one component attachment mechanism configured to receive additional components and at least one cable channel. The present disclosure provides devices, systems and methods for an enclosure, the enclosure comprising a chassis having a floor, a frame, and overhead beams, adaptable for immersive audio and/or multimedia production and experience as well as other utility. Briefly, as used herein, “enclosure” means a structure surrounding a space, though such structures may be either open or closed off (or some combination thereof) from its surroundings. For example, the enclosure may be “closed” through the incorporation of walls, ceilings, doors, and windows, or may be more “open” through the lack of sides or walls and/or ceilings. Multiple component attachment mechanisms such as audio components (e.g., speakers), screen, lighting and video related attachment mechanisms may be provided. With respect to speakers, the location of each speaker is pre-determined to be at specific mounting points above, to the side, behind, and overhead of a listener, yet capable of adjustment based on at least one of a pre-determined audio format and a user preference. The floor generally comprises a plurality of interconnected panels and/or perimeter panels and the frame generally comprises vertical uprights and overhead beams, with attachment mechanisms for speakers, lighting, acoustic treatment, projectors, and cameras.

### BRIEF DESCRIPTION OF THE DRAWINGS

The accompanying drawings are included to provide a further understanding of the disclosure and are incorporated in and constitute a part of this specification, illustrate embodiments of the disclosure, and together with the description serve to explain the principles of the disclosure, wherein:

FIG. 1 is a perspective view of a floor system in accordance with the present disclosure.

FIG. 2 is a perspective view of an enclosure with various components and mechanisms as contemplated and in accordance with the present disclosure.

FIG. 3 is a perspective view of a panel with attachment mechanisms, access panels and cable channels in accordance with the present disclosure.

FIG. 4 is a perspective view of the panel of FIG. 3 with a component attached thereto in accordance with the present disclosure.

FIG. 5 is a cross-sectional view of the panel of FIG. 3 in accordance with the present disclosure.

### DETAILED DESCRIPTION OF THE ILLUSTRATED EMBODIMENTS

Persons skilled in the art will readily appreciate that various aspects of the present disclosure can be realized by any number of methods and systems configured to perform the intended functions. Stated differently, other devices, methods and systems can be incorporated herein to perform the intended functions. It should also be noted that the accompanying drawing figures referred to herein are not all drawn to scale but may be exaggerated to illustrate various aspects of the present disclosure, and in that regard, the drawing figures should not be construed as limiting. Finally, although the present disclosure can be described in connection with various principles and beliefs, the present disclosure should not be bound by theory.

In general, the present disclosure provide devices, systems and methods for enclosures, such as multimedia enclosures, that are designed from the “inside out,” starting with a desired mix position an engineer or artist desires. In this regard, rather than being constrained to a pre-determined space dictated by an existing room or workspace and then accommodating or compromising based on the space, enclosures in the form of a “creative workspace” contemplated herein are determined by the specific desires and needs of the engineer or artist and designed from that perspective. In this respect, the enclosure can be considered as a component of the overall equipment and gear used in the creative workspace. As described in more detail herein, such enclosures are flexible and adaptable, allowing the user to easily customize the dimensions and shape of the enclosure, as well as to position and re-position multimedia components as required by their needs. In this respect, instead of drilling holes in walls and semi-permanently attaching speakers and other components, the enclosures are easily adjustable. Similarly, because the enclosures are comprised of materials that can be erected within an existing space, oftentimes additional contractors and building permits are unnecessary, allowing for added efficiency in terms of time and the cost for construction. Moreover, the enclosures are not limited to a fixed in location and instead, can be semi-or completely disassembled and transported to a new location if desired, which may further eliminate the “waste” of the inability to transport or use existing components in more static, prior art structures. This is of significant value given ever changing industry requirements.

Moreover, the aesthetics and creative environment are improved. For example, a clean and organized arrangement of the enclosure is superior to working in existing prior art enclosures which may have systems of exposed tubes and trusses with visible cables and other unaesthetic aspects. Further, enclosures contemplated herein generally cost less than prior art enclosures.

Additionally, the enclosures can be designed and constructed more consistently across installations. In accordance with some aspects of the present disclosure, multiple enclosures may be capable of being networked together to create a multi-unit configuration through a LAN on one site or over the internet (or other connectivity) across different sites. Additionally, as described below, in accordance with some aspects of the present disclosure, the enclosures can seamlessly integrate immersive video and audio with capability for projecting video onto a range of video screen configurations.

The above being noted, in accordance with various aspects of the present disclosure, multimedia enclosures generally comprise a “chassis” having some combination of a floor, a frame, and/or overhead beams. The chassis defines the enclosure, which may be suitable for housing various multimedia components. As will be described in more detail herein, the various structure of the chassis typically includes at least one cable channel, often with at least two electronically isolated cable troughs or raceways for managing cables as needed. In accordance with various aspects, the floor may include a plurality of interconnected panels, the interconnected panels comprising at least component attachment mechanism configured to receive a variety of components and devices such as one or more speaker stands, various acoustic treatments, exterior coverings and the like.

In accordance with various aspects of the present disclosure, the frame comprises generally vertical uprights attached to the floor and a plurality of overhead beams attached to the vertical uprights. The frame may be attached to the floor and overhead beams using any conventional fastening mechanisms, including brackets, bolts, nuts and screws, welding and adhesives, or other suitable fastening mechanisms. The overhead beams may comprise a plurality of beam attachment mechanisms for a variety of components and devices such as overhead speakers, overhead lighting, acoustic treatments, projectors, displays, cameras and the like.

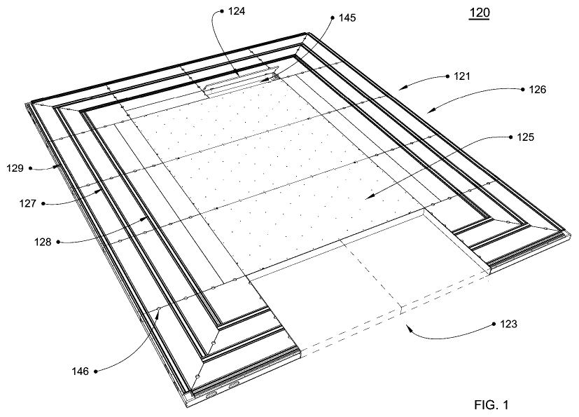

In light of the above and with reference now to FIG. 1, various aspects of the present disclosure may inure themselves to any room, workshop or similar spaces already constructed, which can benefit from additional adaptability, whether or not specifically related to multimedia applications. For example, in accordance with various aspects of the present disclosure, a modular floor system 120 may be provided comprising a plurality of interconnected panels 125, the interconnected panels 125 being locked together and, optionally, comprising at least one component attachment mechanism configured to receive additional components and/or at least one cable channel 145, which may be electrically isolated from other cable channels 145 and/or other components.

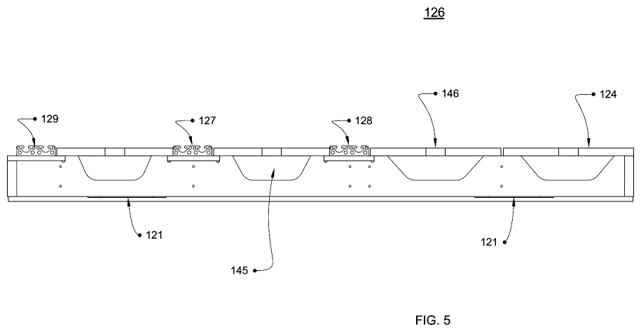

In accordance with various aspects of the present disclosure, the interconnected panels 125 may be connected and/or locked to one another by any now known or as yet unknown manner via panel connectors. For example, with momentary reference to FIG. 5, in an embodiment, the interconnected panels 125 may be connected to one another by joining plates 121 which connect to adjacent panels 125.

The interconnected panels 125 may be configured as a frame and a surface with space or “depth” underneath the surface to hide and otherwise store and manage the components contemplated herein. Such configurations may be particularly useful in connection with wood and machine shops where a variety of cords, air, vacuum, and dust systems are needed, yet for safety and other practical reasons, it is desirable to hide and/or manage the same.

In accordance with some aspects of the present disclosure, the modular floor system 120 may comprise a plurality of perimeter panels 126 arranged about the perimeter of the floor system 120, which may or may not include panels 125 inside the perimeter panels 126 (leaving the space “free” of any panels 125). In such embodiments, the original floor of the space where the modular floor is located remains the same and, by including an entry or “gap” 123 in the perimeter panels 126, ingress and egress into the room can occur without the need to “step up” or provide a ramp to enter the room with the modular floor system 120. This may be beneficial for a variety of reasons, including with regulations such as compliance with the Americans with Disabilities Act (ADA) and similar rules and regulations. In accordance with alternative aspects, where a step up is not an issue or where a ramp or other means for ingress or egress are unnecessary, the perimeter panels 126 may surround one or more optional interior panels 125 that either partially or completely complete the floor.

In accordance with various aspects of the present disclosure, the modular floor system 120 may also comprise one or more one access panels 124 in the interconnected panels 125 (interior or perimeter).

In accordance with some aspects, the interconnected panels 125 may include at least one rail 127 comprising the component attachment mechanism such a T-slot (described in more detail below), though in other embodiments other means of attachment, such as apertures and various male/female connectors and the like are likewise contemplated. In some embodiments, the component attachment mechanism comprises an aperture into which components are inserted, though any attachments mechanisms now known or as yet unknown should be considered within the scope of the present disclosure.

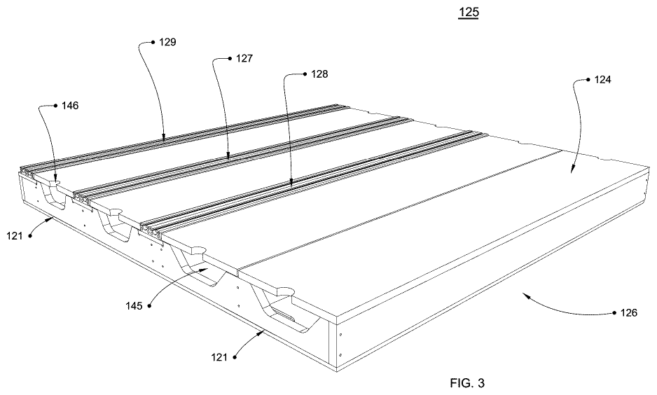

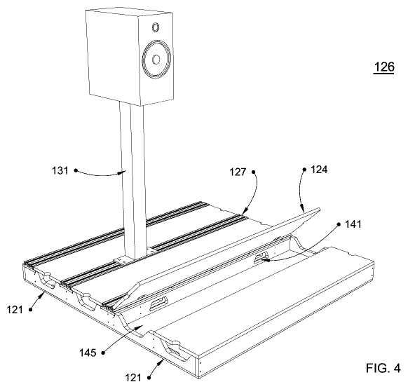

As noted above, the modular floor system 120 may include one or more cable channels 145, for example, for containing power, signal and other cables, air and vacuum lines or other similar items. For example, with momentary reference to FIG. 3, a cable channel 145 is included in a panel 125, though it should be appreciated that cable channels 145 may be present in other structure of the enclosure 100, such as the frame 130, beams 140, and elsewhere. Additionally, in accordance with various aspects of the present disclosure and with reference, for example, to FIG. 4, apertures or “pass throughs” 141 may be provided within various cable channels 145 to allow the various components (e.g., power or audio cords, etc.) to enter/exit other cable channels 145.

In accordance with some aspects, the modular floor system 120 may also include various cable ports 146 for communicating with cables within the at least one cable channel 145. The cable ports 146 may include a variety of outlets such as electrical outlets, various USB and ethernets ports, stems and connectors for air hoses, vacuums, and similar components for connection to the components in the cable channels 145.

In accordance with various aspects of the present disclosure, the modular floor system 120 may further comprise one or integrated power circuits for providing power to various devices which may be present in the room with the modular floor system 120. For example, in one embodiment, two 20-amp circuits may be installed, for example, under the floor. A user can turn on the power at one switch and all systems within the enclosure will power up.

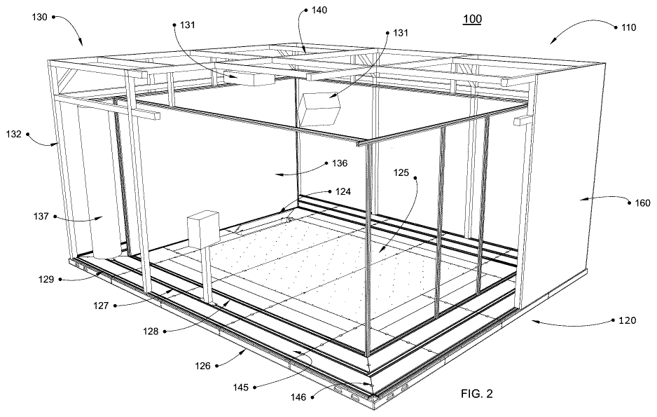

The above being noted, with reference now to FIG. 2, enclosures in accordance with the present disclosure may comprise multimedia enclosures 100. Such multimedia enclosures 100 may comprise a chassis 110 having a floor 120, a frame 130, and overhead beams 140. In accordance with various aspects of the present disclosure, floor 120, a frame 130, and overhead beams 140 may be comprised of materials that are suitably rigid and strong enough to create a safe structure. For example, in accordance with various embodiments, the foregoing components may comprise wood and wood composites, metals (e.g., aluminum, steel, and various sheet metals, etc.), and a variety of other materials, alone or in combination, now known or as yet unknown. In accordance with various aspects, each of the floor 120, a frame 130, and overhead beams 140 may be of the same or different materials than the others. As described herein, in accordance with some aspects of the present disclosure, the enclosures 100 can be disassembled and relocated by the user in as little as one day, and thus, a user's studio is no longer tethered to one installation location,

The chassis 110 thus provides the framework or “skeleton” for an immersive multimedia enclosure for housing, for example, a multi-speaker immersive audio production system, the location of each speaker pre-determined to be at specific mounting points above, to the side, behind, and overhead of a listener, and capable of adjustment based on at least one of a pre-determined audio format and a user preference. The same being noted, while various aspects of the present disclosure may be particularly applicable to immersive audio applications, multimedia enclosures 100 contemplated herein are also useful in connection with stereo formats, as well as other audio formats, even if not considered within the realm of what might be referred to as immersive audio.

Briefly, as used herein, an “immersive audio” format allows a listener to hear audio, for example, music, from all directions around the listener and thus, the listener is “immersed” in the audio. This immersive audio is used to create a sense of space (replicating how we hear sound from all directions in the real world) or for the artistic intent by “placing” sound in different places in the listener's field. Immersive audio is fundamentally different from traditional stereo audio in both its creation and consumption. For example, with traditional stereo and as noted above, sound emanates from two channels (left and right), and the artist/engineer chooses how much of a given sound to send to each of the two channels when mixing a track.

With respect to immersive audio, multiple speakers are used, typically with a minimum of 6 to 12 speakers per room, and often 16 speakers or more. With immersive audio, each “instance” of sound is treated as an “object,” and playback software determines how much of each sound is sent to each speaker. Moreover, the software is designed such that each object of sound will be heard in the listener's listening field in the same way it was “placed” by the engineer, regardless of the speaker configuration (or headphones) the listener may be using.

A common example of an immersive audio format includes primarily Dolby Atmos (“Atmos”), developed by Dolby Labs and a related format called Apple Spatial Audio, developed by Apple, Inc. These formats (along with others such as DTS, Sony 360 and Auro 3D, and similar multi-speaker formats) are all referred to herein generally as immersive audio.

As noted above, these systems typically require a minimum of 6 to 12 speakers per room and are often 16 speakers or more. For example, a typical 12-speaker system might have seven speakers surrounding the listener at or around ear level, four speakers overhead, and an additional subwoofer for low-end frequencies, though the amount and placement of the speakers may vary depending on the particular audio format and particular application or desires of the user. In other words, the number of speakers and their precise placement in the room may vary from format to format and user to user. Moreover, even within a specific format such as Atmos, the recommended speaker placement may change based on updates from the format provider (e.g., Dolby Labs). Thus, immersive audio formats and changes thereto create challenges with integrating a flexible and functional immersive audio set-up in a traditional studio. In accordance with the present disclosure, the systems and structures desired herein address such challenges.

Now, in accordance with the present disclosure, the chassis 110 may comprise at least one cable channel 145, and in some embodiments, the cable channel 145 may include at least two electronically isolated cable troughs therein for containing a variety of components such as power and audio cords used in connection with the immersive audio production system. For example, the troughs may be electronically isolated by a barrier of any material that prevents interference between cords in different troughs, such as metal or polymeric shielding.

In accordance with the present disclosure and with reference to FIG. 3, the cable troughs may further comprise a variety of cable ports 146 for accessing the cable channels 145 and, particularly, the cords therein. Exemplary cable ports 146 may include power outlets (e.g., 110/220V outlets) connected to a power circuit, USB, micro-USB, mini-USB, USB-C, Thunderbolt, ethernet, RCA ports, and any other desirable port for the particular application.

In accordance with various aspects of the present disclosure, the cable channels 145 provide the ability to move various components (such as speakers, computers and the like) to varying locations by virtue of extending throughout and underneath the floor 120 (or other chassis 110 structure) to various locations and in combination with the cable ports, rails and other contemplated attachment mechanisms discussed hereinbelow. Similarly, the overhead beams 140 and the various attachment mechanisms disclosed herein allow continuously adjustable speaker placement.

In accordance with the present disclosure, and with reference to back to FIG. 2, the floor 120 may comprise a plurality of interconnected panels 125. The panels 125 may comprise any material providing sufficient strength, support and/or durability. As briefly mentioned above, non-limiting examples include wood and wood composites, metals, fiberglass and polymers and combinations of the same, now known or as yet unknown. In accordance with various aspects of the present disclosure, the interconnected panels 125 and perimeter panels 126 (described below) may further provide sound isolation, including potential environmental acoustic isolation. As also mentioned above, the interconnected panels 125 may be configured as a frame and a surface with space or “depth” underneath the surface to hide and otherwise store and manage the other components contemplated herein.

With continuing reference to FIG. 2, in accordance with various aspects of the present disclosure, the interconnected panels 125 may further comprise a plurality of perimeter panels 126 surrounding at least one interior panel 125. The perimeter panels 126 may be configured for attachment of various immersive audio related components, such as speaker and speaker stand attachment mechanisms which allow attachment and removal of such components and/or the ability to adjust and vary the placement location of such components. The various interconnected panels 125 and perimeter panels 126 may be locked together by any suitable means, such as tongue and groove interconnection, dovetail connectors, “biscuit” connectors or other suitable fastening techniques, now known or as yet unknown.

In accordance with one embodiment of the present disclosure, the floor 120 may comprise seventeen interlocking panels 125 to form a platform about 16 feet by about 20 feet, though the floor can be scaled to any applicable or otherwise desirable size using a different number of panels or panels of different sizes. In this embodiment, the panels 125 are constructed of an aluminum frame containing a constructed wood panel, incorporating a locking system for connecting the panels 125 together. The panels 125 may be covered with a traditional floor covering such as carpet, tile or the like.

In accordance with the presently described one embodiment disclosure and with reference to FIG. 4, the perimeter panels 126 may comprise one or more aluminum rails, though any suitable now known or as yet unknown material may likewise be used. For example, FIGS. 4 and 5 illustrate three extruded aluminum rails 127, 128, 129 with a T-slot 133. In the case of rails with T-slots 133, the T-Slots are the attachment mechanisms for incorporating various vertical components of the enclosure 100. In this embodiment, the inner rail 128 is utilized for components such as video screens, thereby creating a “room within a room.” The inner rail 128 may also be used to accommodate speaker stands and/or other acoustic treatments, while the outer rail 129 may be used for attaching the frame 130 and/or exterior coverings.

In accordance with various aspects of the present disclosure and with reference to FIG. 5 illustrating one interconnected panel 125, one or more access panels 124 may be provided in the interconnected panels 125 and perimeter panels 126 for accessing components beneath the floor 120, including multimedia system components. The access panels 124 may comprise covers that are removable, slidable, connected hinges, or the like so that the access within may be closed off when access is unnecessary.

In accordance with one aspect of the present disclosure, a perimeter panel 126 may comprise at least one rail, wherein the rail comprises at least one rail attachment mechanism 127 (such as the above-mentioned T-slot, though other attachment mechanisms are likewise contemplated herein) configured to receive a speaker stand (or the speaker itself). In accordance with various aspects, the rail attachment mechanism or mechanisms 127, 128, 129 may also (or alternatively) be configured for the attachment of an exterior covering 160 (see FIG. 2) which encloses the chassis 110. In accordance with one aspect of the present disclosure, the exterior covering 160 is any suitable material, including wood and wood composites, drywall, or other conventional building materials. In some embodiments, the exterior covering 160 may be acoustic panels removably attached to the chassis 110, though the acoustic panels may be distinct from the exterior covering 160 itself. For example, different users may have unique needs for internal acoustic treatment to achieve the acoustic results desired. While prior art solutions for installing acoustic panels in rooms involve adhering acoustic treatment to walls, this does not accommodate easy moving or adjusting. In accordance with the present disclosure, by being removably attachable and moveable, for example by mounting on a rail attachment mechanism 127, the acoustic and easily adjustable, movable, and replaceable.

In accordance with additional aspects of the present disclosure, additional rails may also be provided. For example, with reference to back to FIG. 4, an additional outer rail 128 or inner rail 129 (on either side of a now middle rail 127) may be included for attachment of various components contemplated herein.

In accordance with various aspects of the present disclosure and with reference again to FIG. 2, the frame 130 comprises a plurality of vertical uprights 132 with a plurality of overhead beams 140 attached thereto, as noted above, by any conventional manner. The frame 130 is thus an upright “skeleton” of the enclosure 100. In accordance with one embodiment of the present disclosure, the frame 130 is comprised of conventional aluminum T-slot beams, though custom design or proprietary extrusions are contemplated, which are cut or ordered to pre-determined lengths to provide a vertical and overhead grid. The vertical uprights 132 provide support to the overhead beams 140 and provide attachment points for internal components and exterior coverings. The uprights 132 may also incorporate various channels and troughs and other cable management to provide and manage power and signal cabling to the overhead components, while simultaneously separating the signals and providing a discrete aesthetic.

The overhead beams 140 are generally attached horizontally to the vertical uprights 132, though they may be angled with respect to the vertical uprights 132, depending on the particular application, aesthetics, or the like. The overhead beams 140 provide a grid configuration to attach overhead speakers, lighting, and acoustic treatments and/or other multimedia components. The use of a grid configuration allows the user to move components (e.g., overhead speakers) as necessary for the particular audio format configuration. In the present embodiment, speakers are attached with standard speaker mounts, though other custom or proprietary mounts may be substituted.

In accordance with various aspects of the present disclosure, the overhead beams 140 further comprise a plurality of beam attachment mechanisms for multimedia components 131 such as overhead speakers, overhead lighting, overhead acoustic treatment, projectors, cameras or any other component for which it may be desirable to attached overhead. In accordance with various aspects of the present disclosure and with continuing reference to FIG. 2, the overhead beams 140 may further comprise at least one display attachment mechanism for video display, such as a projection screen 136 which displays an image from a projector (which may also be mounted overhead) or other video monitor.

In the case of a projection screen 136, the screen 136 (or any number of multiple screens 136) may be sound transparent allowing sound to pass therethrough generally unimpeded. For example, in accordance with some aspects of the present disclosure, the screen 136 may comprise a layered Lycra or similar fabric this is attached to the frame 130 and or overhead beams 140. In various embodiments, screens 136 can be attached on one wall (for simple plane viewing), surrounding three sides (for wrap-around viewing or gaming), or four walls (for full immersive video). Thus, immersive audio and immersive video can be combined as a component of visual arts such as TV, cinema, and other multimedia such as the fully integrated nature of video during live music performances.

In accordance with the present disclosure, the multimedia enclosure 100 may further comprise a place for adding or including a control system for controlling aspects such as lighting (levels, color, etc.), HVAC systems, electronic systems, audio and/or video playback devices, and the like. For example, in accordance with some embodiments, the components may be controlled by one or more switches and/or tablets, phones or computers, for example, via a software application.

In accordance with the present disclosure, the multimedia enclosure 100 may further comprise one more bass traps 137 or similar device designed to absorb low-frequency sound waves (bass) to reduce unwanted resonances and create a more balanced sound by preventing excessive buildup of bass frequencies, particularly in corners where low frequencies tend to accumulate.

In accordance with the present disclosure, the multimedia enclosure 100 may further comprise now known or as yet unknown video playback devices, video recording systems and audio recording systems or combinations thereof.

In accordance with the present disclosure, the multimedia enclosure 100 may include various furnishings such as fabrics, carpeting, screens, and various furniture (e.g., desks, chairs, tables, etc.) depending on the specific need. In some embodiments, the entirety of the enclosure 100 may be packaged in such a way as to be delivered to the customer as a “studio in a box.”

In accordance with the present disclosure and in light of the disclosure above, the multimedia enclosures 100 thus provide an adaptable framework for users to easily install any speaker configuration—including the number of speakers used and their placement—for immersive audio production. The enclosures 100 are agnostic to a user's choice of speakers or the audio format because it easily accommodates changes in the number of speakers or the placement a user or format requires. This is contrasted to a fixed in-room installation, where speakers are attached to walls and ceilings with brackets by drilling to drywall and attaching to frames and do not easily accommodate frequent or small moves to a speaker.

Thus, the various enclosures contemplated in accordance with the present disclosure provide a turnkey, modular system for easily installing a fully functional multimedia enclosure that can be applied in many areas and technical fields, including, but are not limited to:
Immersive audio production
TV and video post-production
Cinematic production
Gaming production and creation
Simulators
Education and Training
3D video and audio capture
Health and wellness applications, such as an immersive space for sound healing
3D art installations
3D and immersive brand activations
Rehearsal space for artists' immersive concert productions
Video production space for immersive concerts (e.g., video content for artists playing at location such as The Sphere in Las Vegas, Nevada)
Touring applications—portable immersive studio for rehearsal or content creation during tours
On-Set application—immersive audio studio on cinematic or TV sets during production, as opposed requiring wait until post-production
Military applications for quick assembly rooms.

Finally, it will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

Likewise, numerous characteristics and advantages have been set forth in the preceding description, including various alternatives together with details of the structure and function of the devices and/or methods. The disclosure is intended as illustrative only and as such is not intended to be exhaustive. It will be evident to those skilled in the art that various modifications may be made, especially in matters of structure, deposition materials, elements, components, shape, size, and arrangement of parts including combinations within the principles of the disclosure, to the full extent indicated by the broad, general meaning of the terms in which the appended claims are expressed. To the extent that these various modifications do not depart from the spirit and scope of the appended claims, they are intended to be encompassed therein.

I claim:

1. A modular floor system, comprising a plurality of interconnected panels, the interconnected panels comprising at least one component attachment mechanism configured to receive additional components and at least one cable channel.

2. The modular floor system of claim 1, further comprising a plurality of perimeter panels surrounding at least one interior panel.

3. The modular floor system of claim 2, wherein at least one perimeter panel comprises at least one rail comprising the component attachment mechanism.

4. The modular floor system of claim 1, further comprising at least one access panel.

5. The modular floor system of claim 1, wherein the component attachment mechanism comprises an aperture.

6. The modular floor system of claim 1, wherein the at least one cable channel contains at least one of a power cable and a signal cable.

7. The modular floor system of claim 1, further comprising cable ports for communicating with a cable within the at least one cable channel.

8. The modular floor system of claim 1, wherein the interconnected panels are locked together.

9. The modular floor system of claim 1, wherein the additional components comprise a multimedia enclosure having a frame, a plurality of vertical uprights attached to the floor, and a plurality of overhead beams, the multimedia enclosure further housing multimedia components and configured for the attachment of at least one of a speaker stand, acoustic treatments and an exterior covering.

10. The modular floor system of claim 9, wherein the plurality of overhead beams are attached to the vertical uprights, the overhead beams comprising a plurality of beam attachment mechanisms for at least one of an overhead speaker, overhead lighting, an acoustic treatment, a projector, a display, and a camera.

11. The modular floor system of claim 10, wherein the at least one cable channel is configured to provide the ability to move audio components to varying locations.

12. The modular floor system of claim 9, further comprising adjustable acoustic panels removably attached to the frame.

13. The modular floor system of claim 9, wherein the at least one component attachment mechanism comprises at least two rails configured to receive at least one speaker stand and for attachment of an exterior covering.

14. The modular floor system of claim 1, wherein the interconnected panels provide sound isolation.

15. The modular floor system of claim 1, further comprising at least one of a control system for controlling lighting, HVAC, electronic systems, and an audio playback device.

16. The modular floor system of claim 1, further comprising a power circuit.
